(19) United States
(12) Patent Application Publication
(10) Pub. No.: US 2009/0029203 A1
(43) Pub. Date: Jan. 29, 2009

(54) Fuel Cell System With an Electrochemical Hydrogen Generation Cell

(75) Inventors: Stefan Wagner, Berlin (DE); Robert Hahn, Berlin (DE); Konrad Holl, Aalen-Dewangen (DE); Bernd Kreidler, Ellwangen (DE); Martin Krebs, Rosenberg (DE); Dejan Ilic, Ellwangen (DE)

Correspondence Address: IP GROUP OF DLA PIPER US LLP, ONE LIBERTY PLACE, 1650 MARKET ST, SUITE 4900, PHILADELPHIA, PA, 19103, US

(73) Assignees: Varta Microbattery GmbH, Hannover (DE); Frauknhofer Gesellschaft zur Forderung der angewar idten Forschung e.V., Munchen (DE)

(21) Appl. No.: 11/887,754

(22) PCT Filed: Apr. 15, 2006
(86) PCT No.: PCT/EP2006/003486

§ 371 Date: Mar. 7, 2008

(30) Foreign Application Priority Data
Apr. 18, 2005 (DE) 10 2005 018 291.7

(51) Int. Cl. H01M 8/04; H01M 8/18; H01M 8/00

(52) U.S. Cl. 429/17; 429/21; 429/12

(57) ABSTRACT

A system for supplying a consuming appliance with electric energy, including at least one fuel supply unit in the form of a gas evolution cell which liberates a gaseous fuel on passage of an electric current and at least one fuel cell unit in which the gaseous fuel liberated can be reacted with an oxidant to generate electric power.

### RELATED APPLICATION

This is a §371 of International Application No. PCT/EP2006/003486, with an international filing date of Apr. 15, 2006 (WO 2006/111335 A1, published Oct. 26, 2006), which is based on German Patent Application No. 10 2005 018 291.7, filed Apr. 18, 2005.

### TECHNICAL FIELD

This disclosure relates to a fuel cell-based system for supplying a consuming appliance with electric energy.

### BACKGROUND

Portable appliances such as cell phones and laptops are now an integral part of everyday life. To make the availability of these appliances as comprehensive as possible, they need an autonomous, mobile energy supply. The reliability and quality of the energy source is therefore of fundamental importance. Batteries or accumulators have traditionally been used as an energy source for mobile appliances. However, operation of appliances using batteries which are not rechargeable is generally very expensive, while accumulators are subject to mechanical and chemical change. In addition, development in the field of portable electronic products is progressing at great speed and is associated with a continually increasing energy demand. Conventional energy sources have hardly kept up with the continually increasing demands. For this reason, the use of mobile fuel cells as a replacement for batteries and accumulators in relatively small appliances such as cell phones and laptops has been discussed for some time.

A fuel cell is an electrochemical cell in which a fuel which is fed in essentially continuously is reacted with an oxidant to produce usable electric energy by direct energy transformation from chemical energy.

As fuel, use is made of, inter alia, hydrogen, hydrazine, methane, natural gas, petroleum spirit, alcohols such as methanol or sugar solutions. Oxidants are, for example, oxygen, hydrogen peroxide or potassium thiocyanate. In the case of oxygen as oxidant, the reaction is known as “electrochemical combustion.”

In general usage, the term “fuel cell” usually refers to a hydrogen-oxygen fuel cell in which hydrogen serves as fuel and oxygen serves as oxidant. In a hydrogen-oxygen fuel cell, the principle of the electrolysis of water is reversed.

The fundamental distinction is made between low-temperature fuel cells and high-temperature fuel cells. Low-temperature fuel cells generally have a very high electrical efficiency. Owing to their favorable power to weight ratio, they are particularly useful for mobile applications. Low-temperature fuel cells are generally operated at temperatures of from about 60° C. to 100° C. However, owing to this relatively low temperature level, the heat they give off can be utilized only with difficulty. In the case of high-temperature systems, on the other hand, the heat given off can be utilized in a second stage to generate electric energy. The operating temperature of high-temperature systems can be up to 1000° C. The industrially relevant types of fuel cells at the present time include:
the alkaline fuel cell (AFC) having an alkaline electrolyte,
the proton exchange membrane fuel cell (PEMFC) and the direct methanol fuel cell (DMFC) having proton-conducting membranes as electrolytes,
the phosphoric acid fuel cell (PAFC) having electrolytes comprising phosphoric acid,
the molten carbonate fuel cell (MCFC) having alkali carbonate melt electrolytes and
the solid oxide fuel cell (SOFC) having a solid ceramic electrolyte.

The AFC, the DMFC and the PEMFC are low-temperature fuel cells while the SOFC (usual operating temperature in the range from 800° C. to 1000° C.) and the MCFC (usual operating temperature in the range from 600° C. to 650° C.) are high-temperature fuel cells. With a usual operating temperature in the range from 130° C. to 220° C., phosphoric acid cells (PAFCs) occupy an intermediate position between the low-temperature and high-temperature cells.

All these types of fuel cell are generally made up of two electrodes separated from one another by an electrolyte. At the anode (the plus pole), the fuel is oxidized (anode reaction). This releases electrons and forms cations (e.g., H⁺ ions in the case of hydrogen as fuel). The electrons released migrate via an electricity-consuming appliance (for example an incandescent light bulb) in the direction of the cathode. At the cathode (the minus pole), the oxidant is reduced (cathode reaction). This takes up electrons and forms anions (e.g., negatively charged oxygen ions in the case of oxygen as oxidant). The anions formed subsequently react with the cations which have migrated to the cathode. In the case of hydrogen as fuel and oxygen as oxidant, the net result is formation of water as product of the individual reactions.

The reactions occurring in a hydrogen-oxygen fuel cell can be summarized as follows:

2H₂→4H⁺+4e⁻ (anode reaction: oxidation/—release of electrons)

O₂+4H⁺+4e⁻→2H₂O (cathode reaction: reduction/—uptake of electrons)

2H₂+O₂→2H₂O (net reaction: redox reaction).

The electrolyte in a fuel cell performs a number of functions. It ensures, inter alia, ionic current transport in the fuel cell and additionally forms a gastight barrier between the two electrodes. As mentioned above, the electrolyte in alkaline fuel cells is usually a liquid. In the PAFC and the MCFC, inorganic, inert supports together with the electrolyte form an ion-conducting and gastight matrix. In the SOFC, a high-temperature oxygen ion conductor (e.g., a doped zirconium oxide ceramic) generally serves as solid ceramic electrolyte. In the PEMFC, polymer membranes which are permeable to H⁺ ions are used.

The electrodes in fuel cells are frequently gas-permeable, porous electrodes (known as “gas diffusion electrodes”) which have an electrocatalytic layer. The respective reaction gases are brought to the electrolyte through these electrodes. The electro-catalytic layer usually comprises noble metals, Raney nickel, tungsten carbide, molybdenum sulfides, tungsten sulfides or similar suitable materials.

The very fine dispersion of the reaction gas can, however, also be effected without intermediate installation of a gas diffusion device. DE 101 55 349 describes a micro fuel cell system which has a membrane-electrode assembly (an assembly having an ion-conducting membrane provided with an electrocatalytic layer, known as MEA for short) which is provided both on the cathode side and on the anode side with a power outlet foil. The power outlet foils have diffusion channels which ensure very fine diffusion of the reaction gas on the MEA.

To supply a fuel cell with hydrogen or another reaction gas, it is usual to use a large-volume gas storage, for example in the form of a bottle. Hydrogen can also be stored in the form of a metal hydride storage alloy. However, there are increasingly serious safety concerns about the storage of relatively large quantities of hydrogen.

As mentioned at the outset, it is possible to use either hydrogen or, for example, other fuels such as methanol or natural gas. However, some of the abovementioned types of fuel cell (e.g., the AFC) are not suitable for direct reaction of fuels other than hydrogen. In this case, fuels such as natural gas or petroleum spirit firstly have to be converted into hydrogen and carbon dioxide. This requires a reformer. A reformer is an external apparatus which converts the fuel used into hydrogen-rich process gas.

A DMFC, on the other hand, allows direct reaction of methanol without prior reforming to obtain a reaction gas having a high hydrogen content. The liquid methanol is converted directly into protons, free electrons and carbon dioxide. As a further development of the PEM fuel cell, the DMFC is, like its parent, equipped with a polymer membrane as electrolyte (see above). However, in operation of a DMFC, there is usually undesirable permeation of unconsumed methanol to the cathode side, known as methanol crossover, because of the good solubility of methanol in water. Due to methanol crossover, use is frequently made of a dilute methanol/water mixture whose concentration has to be regulated in a complicated fashion by means of pumps and sensors.

Owing to the relatively high energy density of methanol, the focus of most work in the field of energy supply for portable electronic appliances is at present on direct methanol fuel cells, despite the disadvantages mentioned. As an alternative, increasing attention is also being paid to a combination of fuel cell and microreformer. However, despite great efforts, it has hitherto not been possible to progress the development of these energy systems to mass production. There is still an urgent need for very small energy sources for portable electronic appliances.

It could therefore be advantageous to provide a reliable energy system which is based on fuel cell technology and, in particular, meets the energy requirements of portable electronic appliances and has a high energy density.

### SUMMARY

We provide a system for supply a consuming appliance with electric energy, including at least one fuel supply unit in the form of a gas evolution cell which liberates a gaseous fuel on passage of an electric current and at least one fuel cell unit in which the gaseous fuel liberated can be reacted with an oxidant to generate electric power.

We also provide a method of operating a fuel cell in which a gaseous fuel is reacted with an oxidant to generate electric power, including electrochemically producing the fuel to be reacted and/or the oxidant to be reacted in at least one gas evolution cell connected in a substantially gastight manner to the fuel cell.

We further provide a fuel cell including a gas evolution cell as a fuel source.

### BRIEF DESCRIPTION OF THE DRAWINGS

Further features can be derived from the drawings and from the following description of preferred structures in conjunction with the claims. The individual features can each be realized individually or in combinations of a plurality thereof in a representative structure. The particular examples described serve merely for the purposes of illustration and for a better understanding and are not to be interpreted as any form of restriction. The drawings described below are also part of the present description and are hereby expressly incorporated by reference.

FIG. 1 shows a cross section of a gas evolution cell suitable as fuel supply unit.

FIG. 2a shows a cross section of a preferred system having a plurality of fuel cell units and a plurality of fuel supply units.

FIG. 2b shows the flat upper side of the housing of the system depicted in FIG. 2a in which a plurality of fuel cell units are used.

FIG. 3 shows a valve in the form of a simple, slitted membrane which is suitable for regulating the supply of fuel from the gas evolution cell to the fuel cell unit.

FIG. 4 shows a simple electric connection of an embodiment of a system (configured as shown in FIG. 2a or FIG. 2b) to a consuming appliance.

FIG. 5 schematically illustrates the current versus time curve of a system connected as shown in FIG. 4 after a consuming appliance is switched on.

FIG. 6 shows the potential versus time curve of a system connected as shown in FIG. 4 after a consuming appliance is switched on.

FIG. 7 shows an arrangement of four fuel cells on a circular substrate.

FIG. 8 shows a cross section of the schematic structure of a membrane fuel cell with gas diffusion which is suitable as fuel cell unit.

### DETAILED DESCRIPTION

We provide a system for supplying a consuming appliance with electric energy. We likewise provide a method of operating a fuel cell. A new use of a gas evolution cell is also provided.

A system for supplying a consuming appliance with electric energy comprises at least one fuel supply unit and at least one fuel cell unit. When an electric current is passed through the fuel supply unit, the latter liberates a gaseous fuel which can be reacted with an oxidant in the fuel cell unit to generate electric power.

The fuel supply unit is preferably a gas evolution cell. In the gas evolution cell, the gaseous fuel can be produced electrochemically, with the amount of gaseous fuel liberated per unit time being proportional in accordance with Faraday's law to the amount of electric charge which flows through the supply unit per unit time. The fuel supply unit is thus assigned as source of chemical energy to the fuel cell unit.

Particular preference is given to the fuel supply unit and the fuel cell unit being connected in series electrically so that, under load, essentially the same amount of charge flows through the supply unit and through the fuel cell unit. Since the electrochemical process is coupled to the electric current in the gas evolution cell (as described above), more hydrogen is produced when the current increases, while less is produced when the current decreases. The current is in turn coupled to the power requirement of the consuming appliance. If more electricity flows through the consuming appliance, more hydrogen is generated in the gas evolution cell and is converted into electric energy in the fuel cell unit.

As a result, the electric power output of the system can, if required, be matched dynamically to the power requirement of the consuming appliance during operation. This makes it possible to dispense with a separate complicated regulating system. As a result, the system of fuel cell-based energy systems is particularly advantageous. In addition, it is found that the gaseous fuel required by the fuel cell is produced only when required in operation. Large-volume fuel containers are therefore not required, which has a favorable effect on the energy density of the total system.

The gaseous fuel which is reacted in the fuel cell unit is preferably hydrogen. This is produced in suitable gas generation cells.

The oxidant reacted in the fuel cell unit is preferably oxygen, in particular atmospheric oxygen.

In the simplest case, the system has a gas evolution cell as fuel supply unit and a fuel cell unit. Such a system generally delivers a voltage in the range from about 0.5 V to 1.3 V. This voltage can, if appropriate, be matched to the system voltage required by means of a voltage transformer. Higher voltages can be achieved without problems by connecting gas evolution cells and fuel cells in series. The system can in this way be adapted in a simple manner to the respective voltage and current requirements of a consuming appliance.

Preference is given to connecting the same number of gas evolution cells and fuel cells in series.

However, the number of gas evolution cells can also be higher than that of fuel cell units, for example to compensate for gas losses as a result of leaks.

The total power produced by a system can be calculated by multiplying the current by the total voltage of the at least one fuel supply unit and the at least one fuel cell unit.

The gas evolution cell is preferably a hydrogen evolution cell having an electrochemically oxidizable anode. In a hydrogen evolution cell, the reaction gas hydrogen is stored chemically under atmospheric pressure in the form of water as main constituent of the electrolyte. The hydrogen evolution cell preferably has a metal anode, in particular a zinc anode, and a hydrogen cathode and an aqueous, preferably alkaline electrolyte. Particular preference is given to hydrogen evolution cells which comprise, as active material, a paste of zinc powder, potassium hydroxide and a thickener and a cathode composed of a catalyst for the reduction of water. In them, water is produced according to the following reaction equations:

Anode reaction: Zn+2OH⁻ [symbol] ZnO+H₂O+2e⁻

Cathode reaction: 2H₂O+2e⁻ [symbol] 2OH⁻+H₂

Overall reaction: Zn+H₂O [symbol] ZnO+H₂.

In the course of this reaction, the zinc present in the cup is oxidized to zinc oxide. Hydrogen gas is formed at the cathode and can be discharged in the direction of the fuel cell unit.

The reaction proceeds only when electric current flows through the hydrogen evolution cell. The amount of hydrogen evolved is linked to the closed electric charge according to Faraday's law. Thus, the amount of hydrogen formed can be controlled precisely via the current.

The system preferably has a gas evolution cell which in the rest state has an open-circuit voltage of from about 0.25 V to 0.35 V. Suitable gas evolution cells of this type are described, inter alia, in DE 35 32 335, DE 41 16 359 and EP 1 396 899, which are hereby expressly incorporated by reference.

The system particularly preferably has a very thin fuel cell unit, in particular a membrane fuel cell having a proton-conducting membrane as is described, for example, in DE 101 55 349.

In the simplest case, the system comprises one fuel cell unit. If the system comprises a plurality of units, these are preferably arranged next to one another in a plane.

If membrane fuel cells are used as fuel cell units, preference is given to these comprising a membrane-electrode assembly which is provided on the cathode side with a porous power outlet foil and on the anode side with an outlet foil having integrated fine dispersion of fuel. The total membrane-electrode assembly with porous power outlet foil and with integrated fine dispersion of fuel is preferably arranged between two plates. The plate arranged on the side of the porous power outlet foil has, in particular, at least one opening which ensures access of oxidant, in particular atmospheric oxygen. The discharge of reaction products from the fuel cell unit is also preferably effected via this at least one opening. In particular, water of reaction produced can be discharged from the fuel cell unit by free convection. The replacement of the oxidant at the fuel cell cathode preferably also occurs continuously by free convection during operation. For the present purposes, free convection means that particle transport is based exclusively on the effects of a temperature gradient. Additional apparatuses such as fans or pumps, in particular for the transport of the reaction gases, are not required.

The plate arranged on the side of the outlet foil with integrated fine dispersion of fuel preferably has at least one opening which ensures the inflow of fuel, in particular hydrogen, into the at least one fuel cell unit.

In a particularly preferred structure, the system has at least one parallel connection to the at least one fuel cell unit. The at least one parallel connection is preferably designed for very small currents (compared to the current through the at least one fuel cell unit).

In a further, preferred structure, at least one electric rectifier, in particular at least one diode, is connected in parallel to the at least one fuel cell unit. In another preferred structure, at least one resistor is connected in parallel to the fuel cell unit.

The system preferably has a valve, in particular a mechanical valve, which regulates the entry of fuel into the fuel cell unit. In a preferred structure, the valve is a slitted silicone membrane. The valve controls the flow of fuel between gas evolution cell and fuel cell unit. It preferably opens even at a low hydrogen overpressure in the gas evolution cell. Together with the proton-conducting membrane of the fuel cell unit, it prevents entry of surrounding air and moisture into the gas evolution cell via the fuel cell unit.

The fuel cell unit is preferably at atmospheric pressure in the rest state. However, it can be activated quickly when required. In a particularly preferred system, a gas reservoir is arranged as intermediate fuel storage between the supply unit and the fuel cell unit. This intermediate fuel storage serves to even out power peaks and also ensures rapid response of the system.

Preference is given to the system comprising at least one connection, in particular in the form of an adapter, which connects the at least one fuel supply unit to the at least one fuel cell unit in a gastight manner so that no hydrogen is lost during operation.

The connection is particularly preferably configured as a housing which encloses the at least one fuel supply unit in a gastight manner. The housing preferably has an electrically insulating part and, located in this, a metal lid which functions as minus power lead of the overall system. The at least one fuel cell unit is preferably used with the anode side facing inward into the gastight housing. A contact functioning as plus pole of the overall system is preferably arranged on the outside of the at least one fuel cell unit.

In a particularly preferred structure, the fuel supply unit of a system is exchangeable. For this purpose, the housing is preferably provided with an opening which closes in a gastight manner and via which an exhausted fuel supply unit can be replaced by a full one. It should be emphasized that naturally only the fuel supply unit has to be replaced. The fuel cell unit can remain in the system.

The dimensions of a system are preferably selected so that a primary battery can be replaced thereby. The system can, for example, be constructed with the dimensions of a monocell (i.e., with a height of about 6 cm and a diameter of about 3.4 cm) or a triple A microcell or double A microcell (with a height of about 4.5 cm and a diameter of about 1 cm or a height of about 5.1 cm and a diameter of about 1.5 cm).

A method of operating a fuel cell is also provided. According to the method, a gaseous fuel is reacted with an oxidant to generate electric power, with the fuel to be reacted and/or the oxidant to be reacted being produced electrochemically in at least one gas evolution cell connected in a gastight manner to the fuel cell.

Particular preference is given to the fuel cell and the gas evolution cell being connected in series electrically so that under load the same amount of charge flows through the fuel cell and through the gas evolution cell.

Due to the connection in series, the power requirement of the consuming appliance is, as described above, coupled to the evolution of gas in the gas evolution cell and thus to the production of electric power in the fuel cell unit. The method is thus characterized by, in particular, a simple and elegant way of regulating the electric power of the system dynamically and automatically during operation, completely without requiring a separate regulating system. The method can consequently also be considered to be a control method.

The electric power of the system can be regulated essentially via the electrochemical production of the fuel and/or the electrochemical production of the oxidant to be reacted. In the present case, regulation via fuel production is preferred.

As fuel, preference is given to using hydrogen.

As a gas evolution cell, preference is given to using a hydrogen evolution cell having an electrochemically oxidizable anode. The anode is preferably a metal anode, in particular one based on zinc. In addition, the hydrogen evolution cell used preferably has a hydrogen cathode and an aqueous, preferably alkaline electrolyte.

As an oxidant, preference is given to using oxygen. Particular preference is given to using atmospheric oxygen, but it is also conceivable to produce the oxygen electrochemically in a gas evolution cell.

In this case, an oxygen evolution cell having an oxygen anode, a metal oxide cathode (preferably comprising manganese dioxide and pencil graphite) and an aqueous, preferably alkaline electrolyte as described in DE 35 32 335 can be used as gas evolution cell.

We also provide for the use of a gas evolution cell as fuel source for a fuel cell. The use of a gas evolution cell makes it possible, as mentioned above, for relatively large amounts of fuel to be stored safely and liberated only when required in the fuel cell. The above-described, simplified dynamic control of the power of the fuel cell by the consuming appliance is likewise made possible.

In the system, a very high energy density which can be more than twice the energy density in conventional alkaline manganese batteries is achieved.

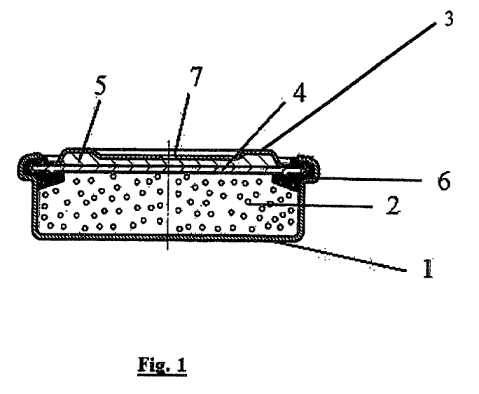

Turning now to the Drawings, the gas evolution cell shown in FIG. 1 has a housing comprising a cup 1, a lid 3 and a seal 6. The cup contains a paste 2 of zinc powder, potassium hydroxide and a thickener as active material. The cathode 4 is located in the lid. The cathode comprises a catalyst for the reduction of water. The cell has an open-circuit voltage in the range from 0.25 V to 0.35 V.

When electric current flows through the gas evolution cell, the zinc present in the cup 1 is oxidized to zinc oxide. Hydrogen gas is formed in the pores of the cathode 4 and escapes into the gas space 5 and can flow through the opening 7 and out of the cell.

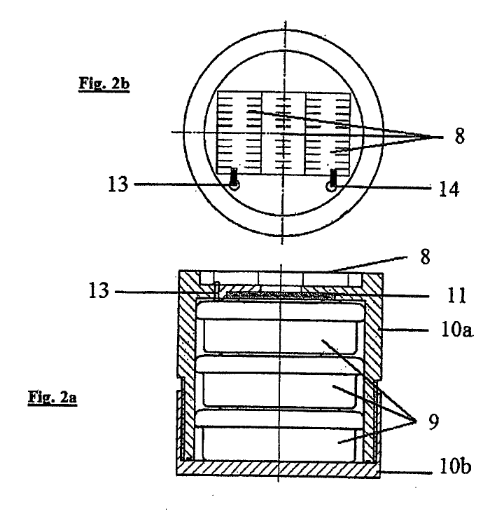

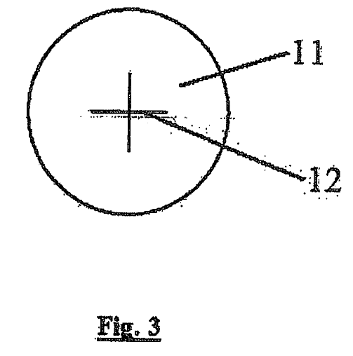

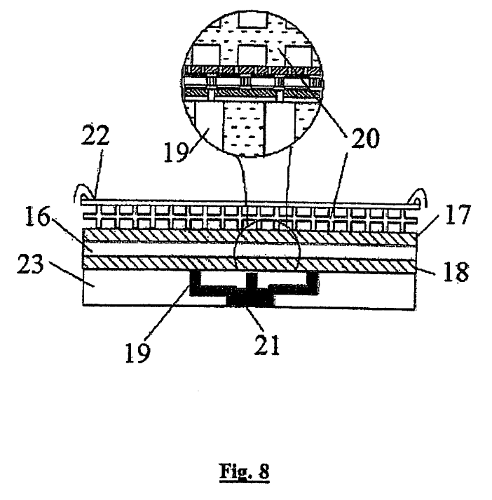

The structure of a fuel cell system shown in FIG. 2a (cross section) and FIG. 2b (plan view) comprises three fuel cell units 8, the three (configured as shown in FIG. 1) gas evolution cells 9 and an adapter 10 which is in the form of a gastight housing around the components. The adapter comprises the electrically insulating part 10a and a metal lid 10b which also functions as minus power lead of the overall system. The gas evolution cells are separated from the fuel cells in the example shown here by a silicone membrane 11 (cf. FIG. 3). The fuel cell units are set in a gastight manner with the anode side facing inward into the insulating part of the housing 10a. These are flat membrane fuel cells as shown in FIG. 8. On the anode side, they have an outlet foil having integrated fine dispersion of fuel.

The three fuel cell units and the three gas evolution cells are connected in series electrically. This achieves a higher electric potential. The electric connection between the fuel cell units and the gas evolution cells is effected by means of the contact 13 which is passed in a gastight manner through the part of the housing 10a. A consuming appliance can be connected via the metal lid 10b (minus pole) and the contact 14 (plus pole).

Under load, the three gas evolution cells connected in series produce hydrogen which passes into the interior space of the gastight housing. The hydrogen flows via the silicone membrane to the fuel cell units in which it is reacted with oxygen.

FIG. 3 shows the abovementioned simple silicone membrane 11 which is provided with the slits 12 and functions as a valve.

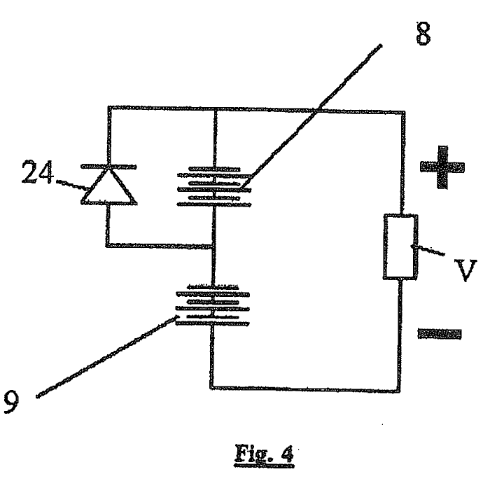

FIG. 4 schematically shows a simple electric connection of a system to a consuming appliance. Three fuel cell units 8 are connected in series to three gas evolution cells 9 (configured as shown in FIG. 1). The gas evolution cells each have an open-circuit voltage in the range from 0.25 V to 0.35 V. If an electricity-consuming appliance V is connected, a relatively small current initially flows via the diode 24 which is connected in parallel to the fuel cell units. As this current flows, evolution of hydrogen according to the reaction equation H₂O+Zn→H₂+ZnO commences in the gas evolution cells. After a short time, the hydrogen pressure in the adapter increases and the hydrogen flows via the membrane 11 to the anode side of the fuel cell units 8. Combustion of hydrogen according to the reaction equation H₂+½O₂→H₂O commences in the fuel cell units. The individual reactions taking place in the fuel cell units and the gas evolution cells can be summarized by the net reaction equation Zn+H₂O→ZnO+H₂.

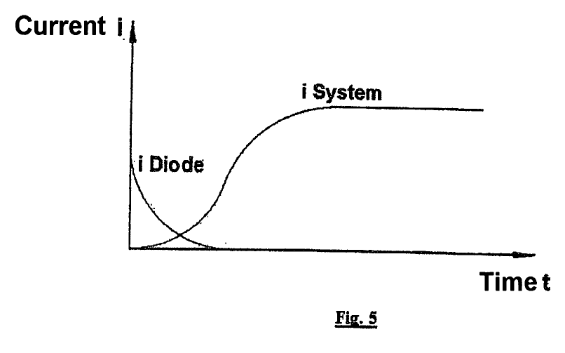

FIG. 5 schematically shows the measured current versus time curve of a system connected as shown in FIG. 4 after a consuming appliance is switched on. The graph shows, after a short delay, a sharp increase in the measured fuel cell current, accompanied by a simultaneous decrease in the current flowing through the diode.

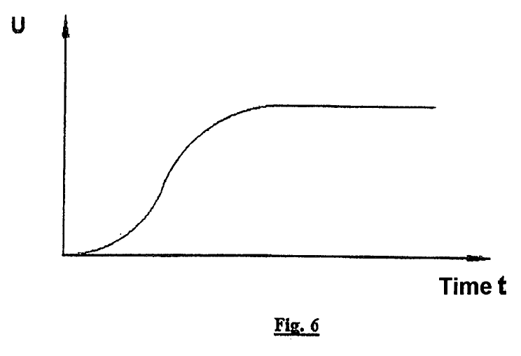

FIG. 6 shows the potential versus time curve of a system after a consuming appliance is switched on. The graph shows a rapid increase in potential after a short delay.

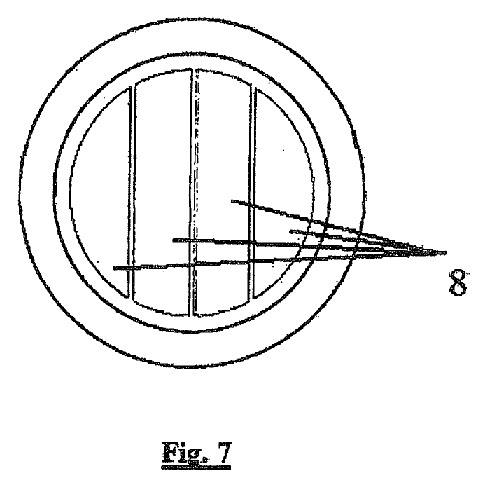

FIG. 7 shows a possible arrangement of four fuel cells 8 on a circular substrate.

FIG. 8 shows a cross section through a membrane fuel cell suitable as fuel cell unit. The membrane fuel cell comprising a porous cathode-side power outlet foil 17, the membrane-electrode assembly (MEA) 16 and the anode-side power outlet foil 18 with integrated fine dispersion of hydrogen is clamped between two plates 20 and 23. The bottom plate 23 takes over the distribution of hydrogen gas from the inlet 21 from the gas evolution cell to the individual fuel cells (individual inlets 19). The upper plate 20 contains grid-like or slitted openings through which the atmospheric oxygen enters or the water of reaction is transported away. The composite is pressed together at the edge by means of clamps or a border 22.

1-13. (canceled)

14. A system for supplying a consuming appliance with electric energy, comprising:
at least one fuel supply unit in the form of a gas evolution cell which liberates a gaseous fuel on passage of an electric current and
at least one fuel cell unit in which the gaseous fuel liberated can be reacted with an oxidant to generate electric power.

15. The system as claimed in claim 14, wherein the supply unit and the fuel cell unit are electrically connected in series so that, under load, essentially the same amount of charge flows through the supply unit and through the fuel cell unit.

16. The system as claimed in claim 14, wherein the gas evolution cell is a hydrogen evolution cell having an electrochemically oxidizable anode, a hydrogen cathode and an aqueous, alkaline electrolyte.

17. The system as claimed in claim 14, wherein the gas evolution cell has an open-circuit voltage of about 0.25 V to about 0.35 V.

18. The system as claimed in claim 14, wherein the fuel cell unit is a membrane fuel cell.

19. The system as claimed in claim 18, wherein the membrane fuel cell comprises a membrane-electrode assembly connected on a cathode side to a porous power outlet foil and on an anode side to an outlet foil having integrated fine dispersion of fuel.

20. The system as claimed in claim 14, further comprising at least one connection in the form of an adapter which connects the at least one supply unit to the at least one fuel cell unit in a gastight manner.

21. The system as claimed in claim 20, wherein the connection is configured as a housing which enclosed the at least one supply unit in a substantially gastight manner.

22. The system as claimed in claim 21, wherein the at lest one fuel cell unit is set with an anode side facing inward into the gastight housing.

23. The system as claimed in claim 14, having external dimensions of a monocell.

24. A method of operating a fuel cell in which a gaseous fuel is reacted with an oxidant to generate electric power, comprising electrochemically producing the fuel to be reacted and/or the oxidant to be reacted in at least one gas evolution cell connected in a substantially gastight manner to the fuel cell.

25. The method as claimed in claim 24, wherein the fuel cell and the gas evolution cell are electrically connected in series so that, under load, the same amount of charge flows through the fuel cell and through the gas evolution cell.

26. A fuel cell comprising a gas evolution cell as a fuel source.
